(19) United States
(12) Patent Application Publication
(10) Pub. No.: US 2001/0046542 A1
(43) Pub. Date: Nov. 29, 2001

(54) Apparatus having a splash guard for preventing splashing

(76) Inventors: George B. Diamond, Glen Gardner, NJ (US); Ralph H. Helmrich, Asbury, NJ (US); Ray G. Slocum, Washington, NJ (US)

Correspondence Address: OSTROLENK FABER GERB & SOFFEN, 1180 AVENUE OF THE AMERICAS, NEW YORK, NY, 100368403

(21) Appl. No.: 09/769,628

(22) Filed: Jan. 25, 2001

Related U.S. Application Data
(60) Provisional application No. 60/178,511, filed on Jan. 27, 2000.
(60) Provisional application No. 60/178,513, filed on Jan. 27, 2000.

(51) Int. Cl. A23B 4/00; A01J 11/04; A23P 1/00; A23L 1/10

(52) U.S. Cl. 426/521; 99/467; 99/473; 426/483

(57) ABSTRACT

Apparatus which includes a container having a side wall, a top end and a bottom end for containing a product under pressure, a raised top end and/or bottom end to provide increased headspace, and, when needed, an internal splash guard for preventing the splashing of the contents when opening of the container. The splash guard may include an internal bead formed in a side wall of the container and may also include an additional internal bead formed in the top end of the container. Headspace may also be increased by reducing the diameter of the concavity formed in the top end. The concavity may also be formed in the bottom end or both the top and bottom end and the top end may comprise an easy open end.

### RELATED APPLICATIONS

This application is based upon and claims priority to U.S. Provisional Application Serial No.: 60/178,511, filed Jan. 27, 2000 entitled “RAISED COVER FOR THIN WALLED CONTAINER” and U.S. Provisional Application Serial No.: 60/178,513, filed Jan. 27, 2000 and entitled “IMPROVED COVER FOR THIN WALLED CONTAINER AND SPLASH GUARD”. The entire contents of the foregoing provisional applications are incorporated by reference herein.

### BACKGROUND OF THE INVENTION

The present invention relates to thin walled containers, such as that disclosed in U.S. Pat. No. 5,804,237, the entire disclosure of which is incorporated herein and, more specifically, to increasing headspace in such a container.

U.S. Pat. No. 5,804,237 is directed to a thin walled, easily crushable container with an integral or seamed-on bottom which is filled with an edible material which requires sterilization. The empty container has one end attached or integral that may have a concave slope relative to the inside of the container. A liquified or solidified inert gas is then inserted into the container. The container is then sealed with a concave shaped end before the inert liquified or solidified gas has completely vaporized. The ends are such that they do not bulge under the pressure left after sterilization, which pressure is due to the pressurization effect of the inert gas and which pressure is enough to overcome the vacuum caused by the cooling of hot water vapor or steam above the edible material and thus gives the can the required rigidity. If one end is concave shaped and will invert or bulge at bacterial gas pressure but not at the gas pressure left after sterilization, then the other end does not necessarily have to be concave as long as it does not bulge at the pressure left after sterilization.

The contents of the container will expand during the heat sterilization process and further compress the compressed gas in the headspace of the container. This may result in a higher internal pressure than desired during the heat sterilization process and may require the use of sophisticated pressure compensating autoclaves.

This over pressurization can be avoided by filling the container to a lower level than normal to increase headspace and reduce the compression effect of the thermal expansion of the container contents. However, under filling is less than desirable since it can create objections in the minds of both the marketer and the consumer.

Further, because of the internal pressure, when such a container is opened, there is a problem that certain products, such as thin fluids may splash and spray out of the container.

### SUMMARY OF THE INVENTION

It is, therefore, an object of the present invention to provide a container having increased headspace in order to prevent over pressurization of the headspace caused by the thermal expansion of the container contents during the heat sterilization process.

It is a further object of the invention to minimize or prevent splashing when a pressurized thin walled container is opened.

These and other objects of the invention are achieved by an apparatus which comprises a container having a side wall, a top end and a bottom end for containing a product under pressure, a raised cover and/or bottom end to provide increased headspace, and, when needed, an internal splash guard for preventing the splashing of the contents when opening of the container.

In accordance with one aspect of the invention, the splash guard comprises an internal bead formed in a side wall of the container and may also include an additional internal bead formed in the top end of the container.

In accordance with another aspect of the invention, headspace may be increased by reducing the diameter of the concavity formed in the top end. The concavity may also be formed in the bottom end or both the top and bottom end and the top end may comprise an easy open end.

Other features and advantages of the present invention will become apparent from the following description of the invention which refers to the accompanying drawings.

### BRIEF DESCRIPTION OF THE DRAWINGS

FIG. 1 is a schematic cross-section of a conventional can having a conventional flat top;

FIG. 2 is a schematic sectional view of a can in accordance with U.S. Pat. No. 5,804,237, having a concave top end showing the level of the contents within the can;

FIG. 3 is a schematic cross-sectional view of a first embodiment of the invention employing a can having a raised top end showing the level of the contents within the can note that the headspace is greater than that in the can in FIG. 2;

FIG. 4 is a schematic cross-sectional view showing a bottom end of a can in accordance with certain features of the present invention being stacked with the top end of another can;

FIG. 5 is a schematic sectional view of a second embodiment of the invention employing a bead in the side wall of the can of FIG. 3 as a splash guard;

FIG. 6 is a schematic sectional view of a variation of the embodiment of the invention shown in FIG. 5 employing a bead in the top end of the can;

FIGS. 7 and 8 are views showing, respectively, a bead in the side wall of the conventional can of FIG. 1 and beads in both the top end and the side wall of the conventional can of FIG. 1;

FIGS. 9-13 are schematic sectional views of a third embodiment of the invention employing a reduced diameter concavity in the top end, with FIG. 9 showing the reduced diameter concavity in the top end with the internal bead; FIG. 10 showing the reduced diameter concavity in the top end without an internal bead; FIG. 11 showing the reduced diameter concavity in the bottom end; FIG. 12 showing the reduced diameter concavity in both the top and bottom ends; and FIG. 13 showing an easy open end having the reduced diameter concavity; and

FIGS. 14-17 are schematic cross-sectional views showing relative diametrical dimensions of the can in accordance with certain features of the invention.

### DETAILED DESCRIPTION OF THE PREFERRED EMBODIMENT(S)

### First Embodiment

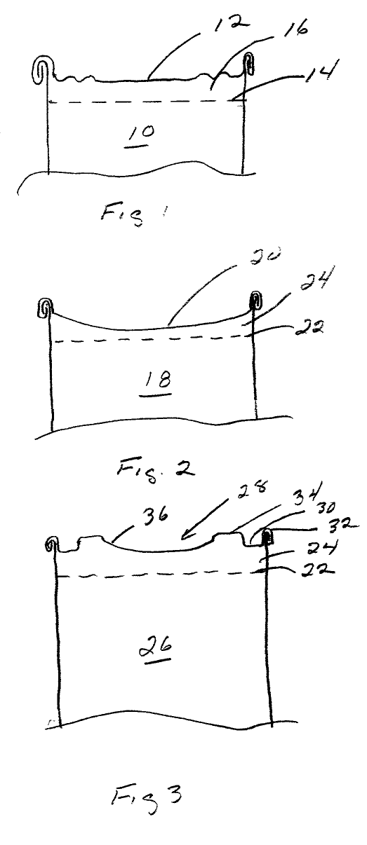

Referring now to the drawings, FIG. 1 shows a conventional can 10 when the pressure in the can 10 is equal to the pressure outside the can 10 and the can 10 uses a conventional flat top end 12. The level of the contents within the can 10 is shown at a level 14, resulting in a headspace 16 between the level 14 and the top end 12.

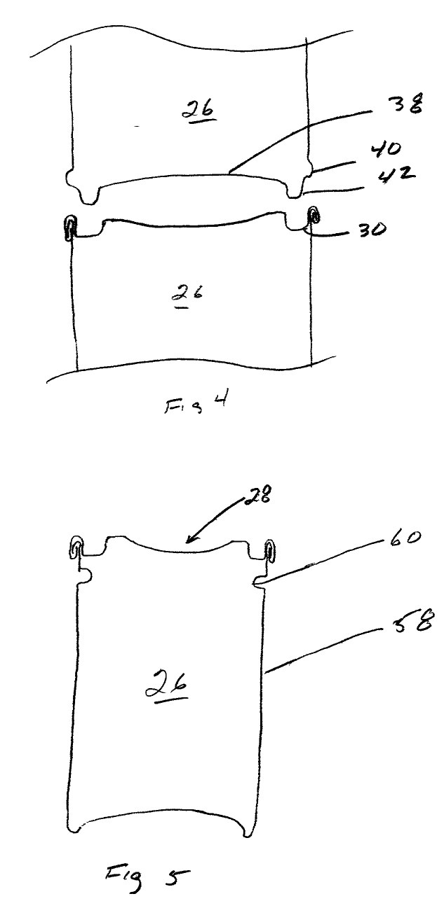

FIG. 2 shows the can 18 and concave end 20 of U.S. Pat. No. 5,804,237. The product level is shown at 22. The headspace 24, i.e., the volume between the concave end 20 and the product level 22, can be seen in FIG. 2 as being smaller than the headspace 16 in the conventional can 10 (FIG. 1).

The contents of the can 10 will expand during the heat sterilization process and further compress the compressed gas in the headspace 24 of the can 18. This may result in a higher internal pressure than desired during the heat sterilization process and may require the use of sophisticated pressure compensating autoclaves.

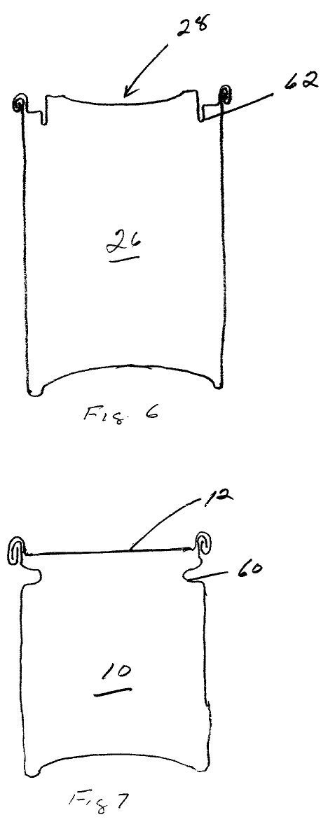

In accordance with certain features of the invention, as shown in FIG. 3, a thin walled can 26, similar to the can 18, is provided with a raised top end 28 to provide increased headroom 24. The raised top end 28 includes a depressed portion 30 adjacent to the chime 32 of the can 26 and an upper flat portion 34 located adjacent to the depressed portion 30. The height of the flat portion 34 is even with the chime 32 and extends inwardly and downwardly to form a concave portion 36.

The raised top end 28 increases the headspace 24 and thereby decreases the compression of the gas in this space due to the high temperature of sterilization having expanded the liquid and/or solid and gas in the can 26. The gas pressure increases due to the temperature increase and to the compression due to the liquid and/or solid expansion is such that combined with the concavity of the end they provide the desired pressure in the empty space. Depending on the product and other conditions this may range from 30 psig to about 70 psig with about 50 psig as an average. This is below the pressure due to bacterial action which causes the end to bulge and become convex. The top end can also be designed so that it flexes upwardly (or outwards) as the internal pressure increases during the sterilization process (thus creating more internal volume in the can and lowering peak pressures). As the pressures increase during the sterilization process, the flexing of the top end 28 occurs at pressures above those pressures experienced at room temperature but below the critical pressure at which the concave portion of the top end will invert to become convex. As the can 26 cools to room temperature, and the internal pressure decreases, the top end 28 will return (by its own springiness) to its original shape. Thus, the top end 28 will raise during sterilization to increase the internal volume of the can to effectively lower the peak internal pressure experienced by the can and will then return to its original shape on cooling.

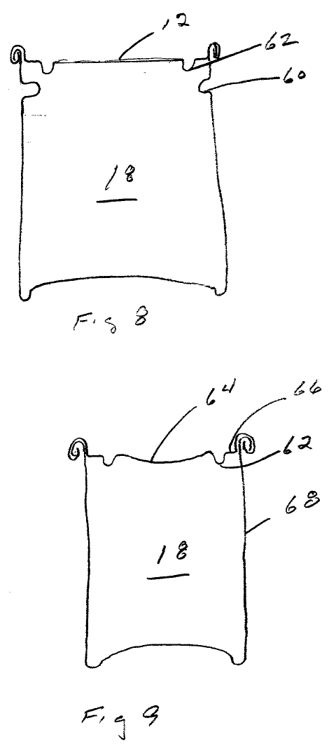

Referring now to FIG. 4, the can bottom end can also be designed in the same manner to further increase the internal volume (and decrease internal pressures) of the can 26 during sterilization. More specifically, the bottom end 38 of the can 26 may be lowered and formed with a rolled-in chime 40 and a projection 42 which enables secure stacking. The projection 42 of the can 26 is designed to fit into the depressed portion 30 of the top end 28 of another can 26 thereby enabling the two cans to be stacked or nested with each other.

### Second Embodiment

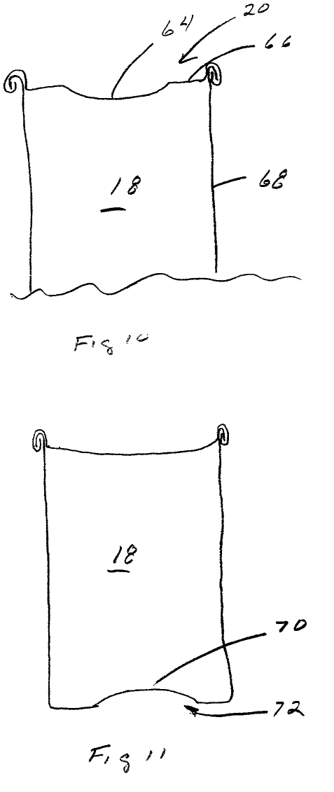

FIG. 5 shows a first embodiment of a splash guard which may be employed to prevent splashing. More specifically, as shown in FIG. 5, the side wall 58 of the can 26 has an interior bead 60. The bead 60 acts as a splash guard to prevent splashing when the can 26 is opened. The extent of the bead 60 into the can is such that it will not interfere with a can opener used to open the can 26.

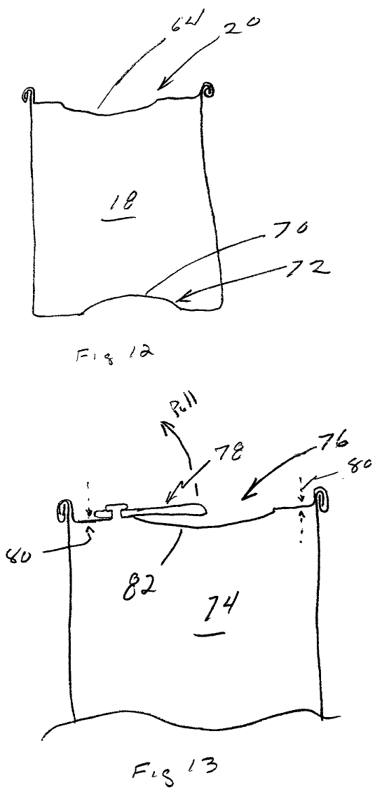

As shown in FIG. 6, in order to provide further assurance against splashing, an internal bead 62 may also be formed in the top end 28. The horizontal spacing of the bead 62 from the side wall of the can is such that it will not interfere with a can opener used to open the can. The can 26 may also include (not shown) both beads 60 and 62.

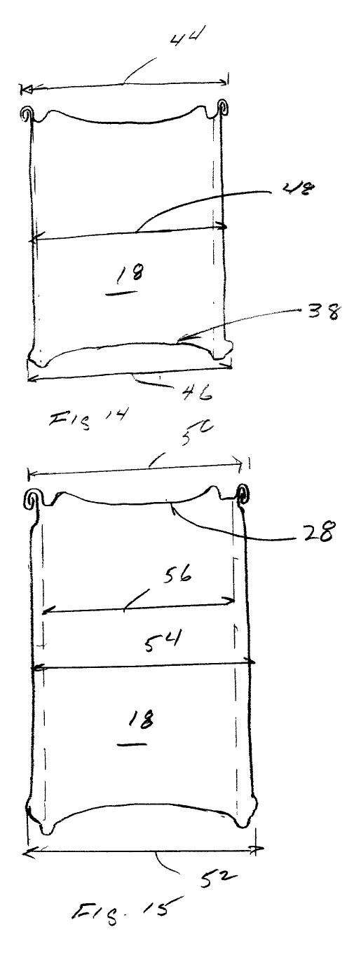

The beads 60 and 62 may also be used in connection with a conventional can 10 having a flat top 12, as shown in FIGS. 7 and 8, to prevent splashing.

### Third Embodiment

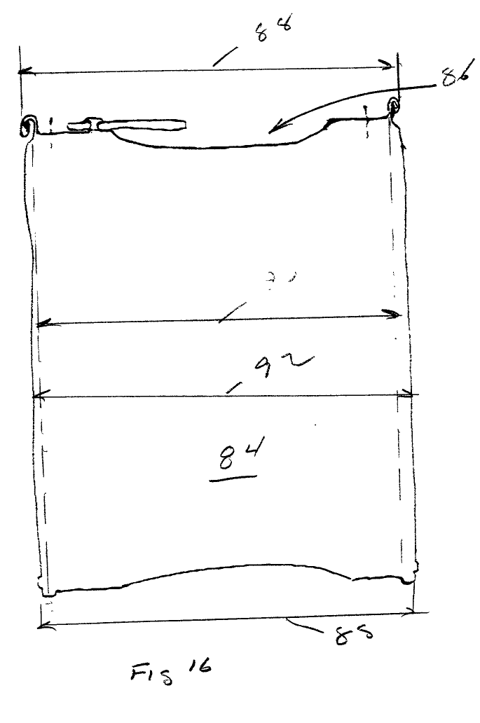

As an alternative to using the raised top end 28 of FIG. 3 to increase headroom, the concavity of the top end 20 may be reduced and depressed as shown in FIGS. 9-13.

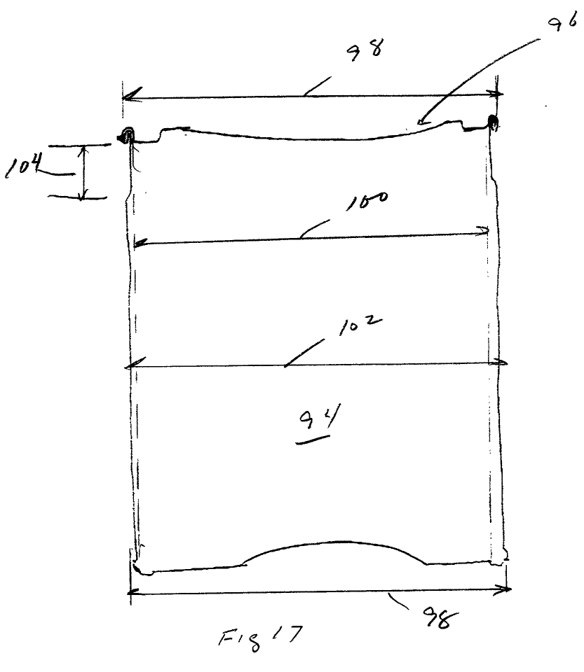

More specifically, FIG. 9 shows a reduced diameter concavity 64 in the top end 20 with an internal bead 62. The reduced diameter concavity 64 is formed by providing a flat portion 66 adjacent the side wall 68 of the can and then depressing the top end 20 inwards of the flat portion 66 to form the concavity 64. If, as in FIG. 10, the top end 22 includes the bead 62, the bead 22 is formed in the flat portion 62. FIG. 11 shows the reduced diameter concavity 64 in the top end 20 without an internal bead 62. FIG. 12 shows a reduced diameter concavity 70 in the bottom end 22. FIG. 13 shows reduced diameter concavities 64 and 70 in both the top and bottom ends 22 and 72. FIG. 14 shows an easy open end 76 with a pull tab 78, a score line 80 and the reduced diameter top concavity 82.

### Fourth Embodiment

Referring now to FIG. 14, the outside chime diameter 44 of the top end 28 of the can 26 is equal to the outside chime diameter 46 of the bottom end 38 of the can 26 to facilitate rolling or handling of the cans 26. The outside diameter of the can itself is designated as 48.

FIG. 15 shows a modification of the can of FIG. 14. As shown in FIG. 15, the upper and lower chime outside diameters 50 and 52 are the same as in FIG. 14. However, the outside diameter 54 is larger than the outside diameter 48 in FIG. 14, but is still smaller than the outside chime diameters 50 and 52, which are the same diameters as the outside chime diameters 44 and 46 in FIG. 14. The inside diameter 56 is the same as the outside diameter 48 of the can of FIG. 14.

Since the chime diameters 50 and 52 are still larger than the (outside) can diameter 54, the can 26 of FIG. 15 still rolls on the chimes and the enlargement of the inside diameter 56 does not interfere with can handling, but allows an increase in the internal volume. For example, an increase in the internal diameter of 0.04 inches in a 3 inches diameter can gives an increase in the internal volume of 0.846 cu. inches or 2.68% in a 407 can. This represents a gain of some 50% of the usual free air space. With the gain in the raised end 44, the total free air space is doubled. With the bottom end lowered, even more air space is obtainable. This is more than sufficient to meet the required pressures as required by the design.

FIG. 16 shows a can 84 with an easy open end 86 wherein the relationships between the outside chime diameter 88, the inside can diameter 90 and the outside can diameter 92 are the same as those in FIG. 15.

FIG. 17 shows a can 94 having a raised top end 96 wherein the relationships between the outside chime diameter 98, the inside can diameter 100 and the outside can diameter 102 are the same as in FIG. 15. In addition, the can 94 has a reduced diameter portion 104 extending below the end 96 to accommodate a conventional can opener.

In all embodiments, corrugations in the top and bottom ends and beads in the can wall, if used, are designed so that the required pressures during processing are maintained below the pressures due to bacterial action.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. Apparatus for containing sterilized edible material, which comprises:
a thin wall sealed container for containing edible material sterilized in a sterilization process and an inert gas under pressure, the side wall of the container being maintained rigid by the pressure of the inert gas but being easily deformable in the absence of such pressure, the container having a top end and a bottom end with at least one end having a concave slope relative to the inside of the container, the at least one end being of a material and having a thickness and shape such that said at least one end of said sealed container will retain a substantially concave slope before, during and after said sterilization process but will become convex only if there is any additional gas pressure generated due to bacterial action in the pressurized, sealed container, the top end having a raised portion being formed inwardly of the side wall.

2. Apparatus in accordance with claim 1, further including an internal bead formed in the side wall of the container and extending inwardly of the side wall.

3. Apparatus in accordance with claim 2, wherein the internal bead is structured and arranged such as to not interfere with a can opener used to open the container.

4. Apparatus in accordance with claim 1, further including an internal bead formed in the top end of the container and extending downwardly from said top end.

5. Apparatus in accordance with claim 4, wherein the internal bead is structured and arranged such as to not interfere with a can opener used to open the container.

6. Apparatus in accordance with claim 1, further including a first internal bead formed in the side wall of the container and extending inwardly of the side wall and a second internal bead formed in the top end of the container and extending downwardly from the top end.

7. Apparatus in accordance with claim 6, wherein the first and second beads are structured and arranged such as not to interfere with a can opener used to open the container.

8. Apparatus in accordance with claim 1, wherein the top end has a diameter and further has a concavity formed in the top end having a diameter smaller than a diameter of the side wall of the container.

9. Apparatus in accordance with claim 8, wherein the top end has a flat portion immediately adjacent the side wall and the concavity is formed inwardly of said flat portion.

10. Apparatus in accordance with claim 9, wherein the bottom end has a diameter and further has a concavity formed in the bottom end having a diameter smaller than a diameter of the side wall of the container.

11. Apparatus in accordance with claim 8, wherein the bottom end has a flat portion immediately adjacent the side wall and the concavity is formed inwardly of said flat portion.

12. Apparatus in accordance with claim 1, wherein the top end has a diameter and further has a concavity formed in the top end having a diameter smaller than a diameter of the side wall of the container and the bottom end has a diameter and further has a concavity formed in the bottom end having a diameter smaller than a diameter of the side wall of the container.

13. Apparatus in accordance with claim 12, wherein the top end and the bottom end have respective flat areas immediately adjacent the side wall of the container and the respective concavities of the top end and the bottom end are formed inwardly of the side wall of the container.

14. Apparatus in accordance with claim 9, wherein the top end is an easy open end having a pull tab and a score line and the concavity is formed inwardly of said score line.

15. Apparatus in accordance with claim 1, wherein the top end includes a depressed area immediately adjacent the side wall of the can and the raised portion is located adjacent and inwardly of the depressed portion.

16. Apparatus in accordance with claim 15 in which the top end includes a concavity located adjacent to and inwardly of the raised portion.

17. Apparatus in accordance with claim 1, wherein the container has an upper chime and the raised portion has a height higher than said upper chime.

18. Apparatus in accordance with claim 16, wherein the raised portion has an upper flat portion a height of which is substantially the same as a height of the upper chime.

19. Apparatus in accordance with claim 1, wherein the bottom end of the container includes a lowered portion, the lowered portion being formed inwardly of the side wall.

20. Apparatus in accordance with claim 19, wherein the bottom end includes a depressed area immediately adjacent the side wall of the can and the lowered portion is located adjacent and inwardly of the depressed portion.

21. Apparatus in accordance with claim 20, in which the bottom end includes a concave portion located adjacent to and inwardly of the lowered portion.

22. Apparatus in accordance with claim 21, wherein the container includes a lower chime and the lower portion has a lower flat portion, a depth of which is substantially the same as a depth of the lower chime.

23. Apparatus for containing contents under pressure and for preventing splashing when opening thereof, which comprises:
a container having a side wall, top end and a bottom end for containing a product under pressure; and
an internal splash guard for preventing the splashing of the contents upon opening of the container.

24. Apparatus in accordance with claim 23, wherein the splash guard comprises an internal bead formed in the side wall of the container and extending inwardly of the side wall.

25. Apparatus in accordance with claim 24, wherein the internal bead is structured and arranged such as to not interfere with a can opener used to open the container.

26. Apparatus in accordance with claim 24, wherein the splash guard comprises another internal bead formed in the top end of the container and extending downwardly from said top end.

27. Apparatus in accordance with claim 24, wherein the other internal bead is structured and arranged such as to not interfere with a can opener used to open the container.

28. Apparatus in accordance with claim 23, wherein the splash guard comprises a first internal bead formed in the side wall of the container and extending inwardly of the side wall and a second internal bead formed in the top end of the container and extending downwardly from the top end.

29. Apparatus in accordance with claim 28, wherein the first and second beads are structured and arranged such as not to interfere with a can opener used to open the container.

30. An improved can having increased volume as compared to a conventional can having a chime diameter D1, an outside can diameter D2 and an inside can diameter D3, wherein D1>D2>D3, the improved can having a chime diameter D4, an outside can diameter D5 and an inside can diameter D6, wherein D1=D4, D4>D5>D2 and D6>D2.

31. An improved can in accordance with claim 30, wherein the can has an upper portion with a reduced outside can diameter sized to accommodate a can opener.

32. An improved can in accordance with claim 30, wherein the can has an easy open end.
